(19) United States
(12) Patent Application Publication
(10) Pub. No.: US 2025/0148241 A1
(43) Pub. Date: May 8, 2025

(54) ROBOTIC SYSTEMS AND METHODS FOR IDENTIFYING AND PROCESSING A VARIETY OF OBJECTS

(71) Applicant: Berkshire Grey Operating Company, Inc., Bedford, MA (US)

(72) Inventors: Thomas WAGNER, Concord, MA (US); Kevin AHEARN, Nebo, NC (US); Benjamin COHEN, Somerville, MA (US); Michael DAWSON-HAGGERTY, Pittsburgh, PA (US); Christopher GEYER, Arlington, MA (US); Thomas KOLETSCHKA, Cambridge, MA (US); Kyle MARONEY, North Attleboro, MA (US); Matthew T. MASON, Pittsburgh, PA (US); Gene Temple PRICE, Cambridge, MA (US); Joseph ROMANO, Arlington, MA (US); Daniel Carlton SMITH, Canonsburg, PA (US); Siddhartha SRINIVASA, Seattle, WA (US); Prasanna VELAGAPUDI, Pittsburgh, PA (US); Thomas ALLEN, Reading, MA (US)

(21) Appl. No.: 18/917,282

(22) Filed: Oct. 16, 2024

Related U.S. Application Data
(63) Continuation of application No. 17/949,936, filed on Sep. 21, 2022, now Pat. No. 12,159,192.
Application No. 17/949,936 is a continuation of application No. 16/800,587, filed on Feb. 25, 2020, now Pat. No. 11,494,575.
Application No. 16/800,587 is a continuation of application No. 15/982,238, filed on May 17, 2018, now Pat. No. 10,621,402.
Application No. 15/982,238 is a continuation of application No. 15/260,837, filed on Sep. 9, 2016, now Pat. No. 10,007,827.
(60) Provisional application No. 62/269,640, filed on Dec. 18, 2015.
(60) Provisional application No. 62/217,200, filed on Sep. 11, 2015.

(51) Int. Cl. G06K 7/14; B07C 5/36; B25J 9/00; B25J 9/16; B25J 19/02; B65G 1/137; G05B 19/12; G05B 19/418; G06K 7/10; G06K 19/06; G06Q 10/087; G06V 20/64; G06V 40/13

(52) U.S. Cl. CPC G06K 7/1443; B07C 5/36; B25J 9/0093; B25J 9/1679; B25J 9/1694; B25J 9/1697; B25J 19/022; B25J 19/023; B65G 1/1373; G05B 19/124; G05B 19/4183; G06K 7/10693; G06K 7/1404; G06K 7/1447; G06K 19/06028; G06Q 10/087; G06V 20/64; G06V 40/1312; G05B 2219/14005; G05B 2219/36371; G05B 2219/45045; G05B 2219/45047; G05B 2219/45063; G06V 2201/06; Y02P 90/02

(57) ABSTRACT

A robotic system is disclosed that include an articulated arm and a first perception system for inspecting an object, as well as a plurality of additional perception systems, each of which is arranged to be directed toward a common area in which an object may be positioned by the robotic arm such that a plurality of views within the common area may be obtained by the plurality of additional perception systems.

### PRIORITY

The present application is a continuation of U.S. patent application Ser. No. 17/949,936, filed Sep. 21, 2022, now U.S. Pat. No. 12,159,192, issued Dec. 3, 2024, which is a continuation of U.S. patent application Ser. No. 16/800,587, filed Feb. 25, 2020, now U.S. Pat. No. 11,494,575, issued Nov. 8, 2022, which is a continuation of U.S. patent application Ser. No. 15/982,238, filed May 17, 2018, now U.S. Pat. No. 10,621,402, issued Apr. 14, 2020, which is a continuation of U.S. patent application Ser. No. 15/260,837, filed Sep. 9, 2016, now U.S. Pat. No. 10,007,827, issued Jun. 26, 2018, which claims priority to U.S. Provisional Patent Application Ser. No. 62/217,200, filed Sep. 11, 2015, as well as U.S. Provisional Patent Application Ser. No. 62/269,640, filed Dec. 18, 2015, the disclosures of which are hereby incorporated by reference in their entireties.

### BACKGROUND

The invention generally relates to robotic and other sortation systems, and relates in particular to robotic and other sortation systems that are intended to be used in dynamic environments requiring the system to accommodate processing a variety of objects.

Many order fulfillment operations achieve high efficiency by employing a process called wave picking. In wave picking, orders are picked from warehouse shelves and placed into bins containing multiple orders that are sorted downstream. At the sorting stage individual articles are identified, and multi-article orders are consolidated into a single bin or shelf location so that they may be packed and then shipped to customers. The process of sorting these articles has been done by hand. A human sorter picks an article from an incoming bin, finds the barcode on the object, scans the barcode with a handheld barcode scanner, determines from the scanned barcode the appropriate bin or shelf location for the article, and then places the article in the so-determined bin or shelf location where all articles for that order are placed.

Manually operated barcode scanners are generally either fixed or handheld systems. With fixed systems, such as those used at point-of-sale systems, the operator holds the article and places it in front of the scanner so that the barcode faces the scanning device's sensors, and the scanner, which scans continuously, decodes any barcodes that it can detect. If the article is not immediately detected, the person holding the article typically needs to vary the position or rotation of the article in front of the fixed scanner, so as to make the barcode more visible to the scanner. For handheld systems, the person operating the scanner looks for the barcode on the article, and then holds the scanner so that the article's barcode is visible to the scanner, and then presses a button on the handheld scanner to initiate a scan of the barcode.

Other ways of identifying items by barcode scanning require that the barcode location be controlled or constrained so that a fixed or robot-held barcode scanner can reliably see the barcode. Automatic barcode scanners also involve either fixed or hand-held systems, and the same principles apply. In the case of barcode scanners typically used in industrial applications, the possible positions of barcodes must be tightly controlled so that the barcodes are visible to the one or more scanners. For example, one or more barcode scanners may be placed in fixed locations relative to a conveyor or series of moving trays so that the scanners may scan objects, typically boxes, as they pass by the scanners. In these installations the range of placement of the barcodes is comparatively limited as they must be on labels affixed to one of four sides or top of a box, which also needs to be presented at orientations suitable for scanning. The detected barcode is then associated with the immediate section of the conveyor or is associated with the particular moving tray in which the object had been placed prior to scanning.

In all of these cases, the systems employ sensors, cameras or laser reflectivity sensors, as well as software to detect barcodes and decode them. These methods have inherent limitations that include the range of distances of orientations relative to the detection system, over which they are able to reliably scan barcodes. Firstly, the barcode must be facing the scanner; secondly the range to the barcode must be such that individual elements can be reliably distinguished; and, thirdly, the tilt and skew of the barcode must be such that individual elements can be reliably distinguished. The types of sensors employed, and the robustness of the software detection and decoding schemes determine these performance parameters. There remains a need, therefore, for an object identification system for a robotic system that is able to accommodate the automated identification and processing of a variety of objects in a variety of orientations.

### SUMMARY

In accordance with an embodiment, the invention provides a robotic system that include an articulated arm and a first perception system for inspecting an object, as well as a plurality of additional perception systems, each of which is arranged to be directed toward a common area in which an object may be positioned by the robotic arm such that a plurality of views within the common area may be obtained by the plurality of additional perception systems.

In accordance with another embodiment, the invention provides a method of identifying an object in a robotic system including an articulated arm. The method includes the steps of inspecting the object using a first perception system and providing an inspection response signal representative of whether the item has been identified, moving the object to a plurality of additional perception systems responsive to the inspection response signal, and inspecting the object using the plurality of additional perception systems, each of which is arranged to be directed toward the object in a common area from a different view of a plurality of views of the object within the common area that may be obtained by the plurality of additional perception systems.

In accordance with a further embodiment, the invention provides a perception system for assisting in identifying an object. The perception system includes a plurality of perception units that are each positioned to be directed toward a plurality of locations along an object path that an object may take as the object travels through the perception system.

### BRIEF DESCRIPTION OF THE DRAWINGS

The following description may be further understood with reference to the accompanying drawings in which:

FIGS. 1A and 1B show an illustrative diagrammatic view of a system in accordance with an embodiment of the present invention;

FIG. 2 shows an illustrative diagrammatic view of a portion of the system of FIG. 1A that includes a plurality of perception units;

FIG. 3 shows an illustrative diagrammatic view of perception image data of a set of objects to be sorted as presented at an infeed station in a system in accordance with an embodiment of the present invention;

FIG. 4 shows an illustrative diagrammatic view of a single simulated hold of an object to be identified in accordance with an embodiment of the present invention;

FIG. 5 shows an illustrative diagrammatic view of multiple overlapping simulated holds of the object of FIG. 4;

FIG. 6 shows an illustrative diagrammatic view of simulated overlapping positions of many barcodes;

FIG. 7 shows an illustrative diagrammatic view of a configuration of perception units based on the modelling of FIGS. 4-6;

FIG. 8 shows an illustrative diagrammatic view of a system in accordance with a further of the present invention;

FIG. 9 shows an illustrative diagrammatic isometric view of a drop perception unit for use in accordance with the system of FIG. 8; and

FIG. 10 shows an illustrative diagrammatic top isometric view of the drop perception unit of FIG. 9.

The drawings are shown for illustrative purposes only.

### DETAILED DESCRIPTION

In accordance with an embodiment, the invention provides an object perception system for the purposes of automatically sorting individual objects in a set. In applications such as order fulfillment, objects are collected into heterogeneous sets and need to be sorted. Individual objects need to be identified and then routed to object-specific locations. The described system reliably automates the identification of such objects by employing both automated barcode scanners and a robotic arm. In accordance with certain embodiments, for example, the system uses the robotic arm to hold the item in front of one or more barcode scanners so that the object may be scanned. In accordance with various embodiments, the perception units (e.g., cameras or scanners) may look for a variety of codes such as indicia (e.g., barcodes, radio frequency tags, Stock Keeping Unit (SKU), Universal Product Code (UPC), low wavelength IR (LWIR), as well as invisible barcodes and digital watermarks such as Digimarc DWCode, etc.).

Whereas fixed industrial scanners require that the object's barcode be situated so that its barcode is visible to a scanner, the robotic arm of the present invention may pick an object out of a heterogeneous collection of objects where the barcode is not visible and scan the item. The result is an automated barcode scanning system for arbitrary items in a heterogeneous stream of objects that may be used to accurately and reliably identify items.

Sorting for order fulfillment is one application for automatically identifying objects from a heterogeneous object stream. Barcode scanners have a wide variety of uses including identifying the stock keeping unit of an article, or tracking parcels. The described system may have many uses in the automatic identification and sortation of objects.

Operating in conjunction with a robotic pick and place system, such a system of an embodiment of the present invention automates part of the sorting process, in particular the step of identifying picked objects. Instead of a person picking the object from a bin, a robotic arm may pick an object from a bin, placed the object in front of a barcode scanner, and then, having obtained identification codes for the object, placed the object in the appropriate bin or shelf location. Since barcode scanners employ cameras or lasers to scan 1D or 2D symbologies printed on labels affixed to articles, the barcodes must be visible to the scanner's sensors for successful scanning in order to automatically identify items in a heterogeneous stream of arbitrary articles, as in a jumbled set of articles found in a bin.

In accordance with various embodiments, therefore, the invention provides a method for determining the identity of an object from a collection of objects, as well as a method for scanning the barcode of an object employing one or more barcode scanners and a robotic arm with end-effector holding the object. The invention further provides a method for determining the placement of fixed barcode scanners so as to maximize the probability of successfully scanning an object held by a robot end-effector in accordance with certain embodiments, as well as a method for determining a sequence of placements of a robot end-effector so as to minimize the time it takes a configuration of one or more barcode scanners to successfully scan an object, and a method for scanning the barcode of an object by employing a barcode scanner as an end-effector on a robotic arm.

An important aspect is the ability to identify objects via barcode or other visual markings of objects by employing a robot arm to pick up individual objects and place or drop them in front of one or more scanners. Automated scanning systems would be unable to see barcodes on objects that are presented in a way that their barcodes are not exposed or visible. Since the system uses a robot to hold the object, it can either maneuver the object so as to make the barcode visible, or employ multiple scanners that view the article from multiple viewpoints to acquire the barcode, irrespective of how the object is held.

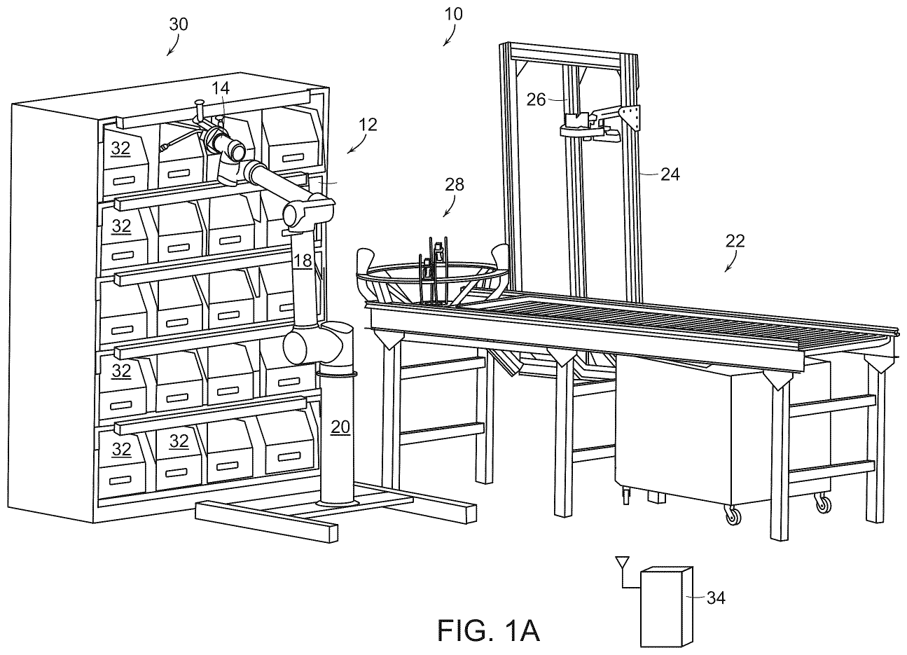

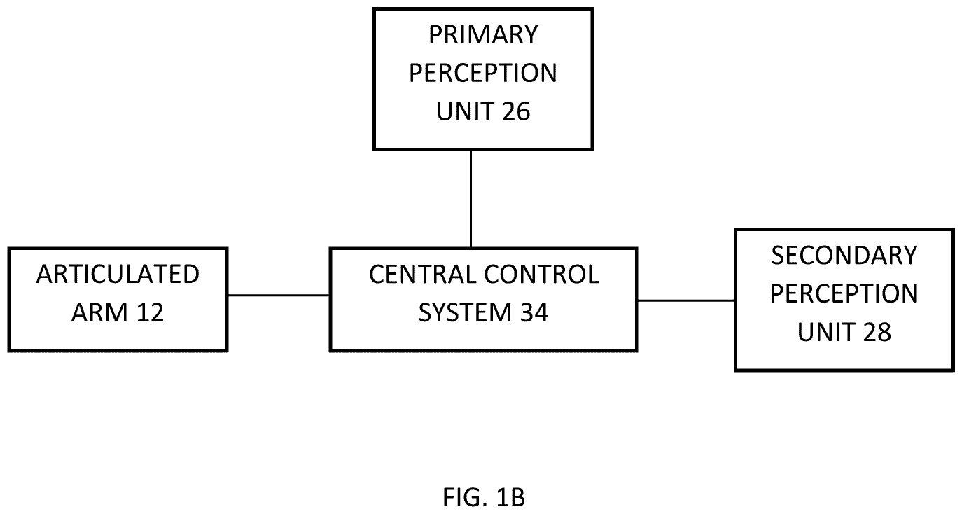

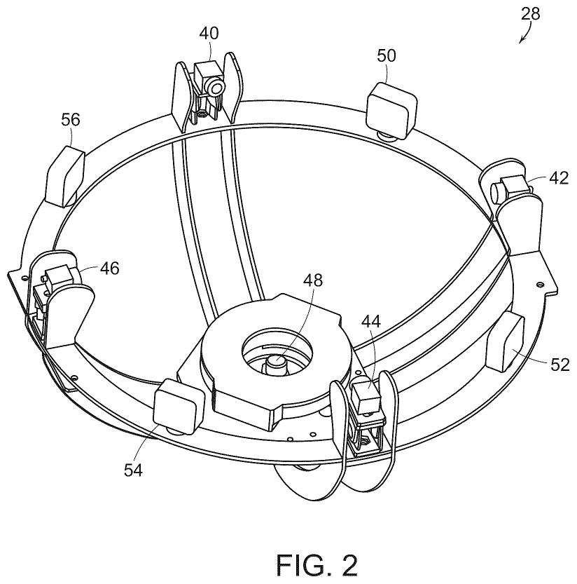

An automated article identification system in accordance with an embodiment of the present invention is shown in FIG. 1A. FIG. 1A shows a robotic system 10 that includes an articulated arm 12 that includes an end effector 14 and articulated sections 16, 18 and 20. The articulated arm 12 selects items from a conveyor 22, that are either in a bin on the conveyor 22 or are on the conveyor itself. A stand 24 includes an attached primary perception unit 26 that is directed toward the conveyor from above the conveyor. The primary perception unit 26 may be, for example, a camera, or a scanner such as a laser reflectivity scanner or other type of bar-code reader, or a radio frequency ID scanner. A plurality of additional perception units are provided on a secondary perception unit 28 (as will be discussed in more detail below with reference to FIG. 2).

The robotic system 10 may further include the robotic environment, a target station 30 that includes a number of bins 32 into which objects may be placed after identification. FIG. 1A and 1B further show a central computing and control system 34 that may communicate with the primary perception unit 26 and the secondary perception unit 28 as well as the articulated arm 12 via wireless communication, or, in certain embodiments, the central computing and control system 34 may be provided within the base section 20 of the articulated arm.

FIG. 2 shows the the secondary perception unit 28 that includes a plurality of perception units 40, 42, 44, 46 and 48, as well as a plurality of illumination sources 50, 52, 54 and 56 for use in certain embodiments of the present invention. Each of the perception units 40, 42, 44, 46 and 48 may be, for example, a camera (e.g., 2D or 3D), or a scanner such as a laser reflectivity scanner or other type of barcode reader (e.g., 1D or 2D barcode scanners), or a radio frequency ID scanner together with the associated software to process the perceived data.

Generally, the system provides in a specific embodiment, an automated article identification system that includes a robotic pick and place system that is able to pick articles up, move them in space, and place them. The system also includes the set of objects themselves to be identified; the manner in which inbound objects are organized, commonly in a heterogeneous pile in a bin or in a line on a conveyor; the manner in which outbound objects are organized, commonly in an array of outbound bins, or shelf cubbies; the manner in which objects are labeled with barcodes or radio-frequency identification tags; a fixed primary scanner operating above the incoming stream of objects; a barcode scanning station where one or more barcode scanners and illuminators are activated when the object is held at the station; and a central computing and control system determines the appropriate location for placing the object, which is dependent on the object's decoded barcode.

As noted, the robotic pick and place system is typically a robotic arm equipped with sensors and computing, that when combined is assumed herein to exhibit the following capabilities: (a) it is able to pick objects up from a specified class of objects, and separate them from a stream of heterogeneous objects, whether they are jumbled in a bin, or are singulated on a motorized or gravity conveyor system, (b) it is able to move the object to arbitrary places within its workspace, (c) it is able to place objects in an outgoing bin or shelf location in its workspace, and (d) it is able to generate a map of objects that it is able to pick, represented as a candidate set of grasp points in the workcell, and as a list of polytopes enclosing the object in space.

The allowable objects are determined by the capabilities of the robotic pick and place system. Their size, weight and geometry are assumed to be such that the robotic pick and place system is able to pick, move and place them. These may be any kind of ordered goods, packages, parcels, or other articles that benefit from automated sorting. In certain embodiments, each object is associated with a stock keeping unit (SKU), which identifies the item.

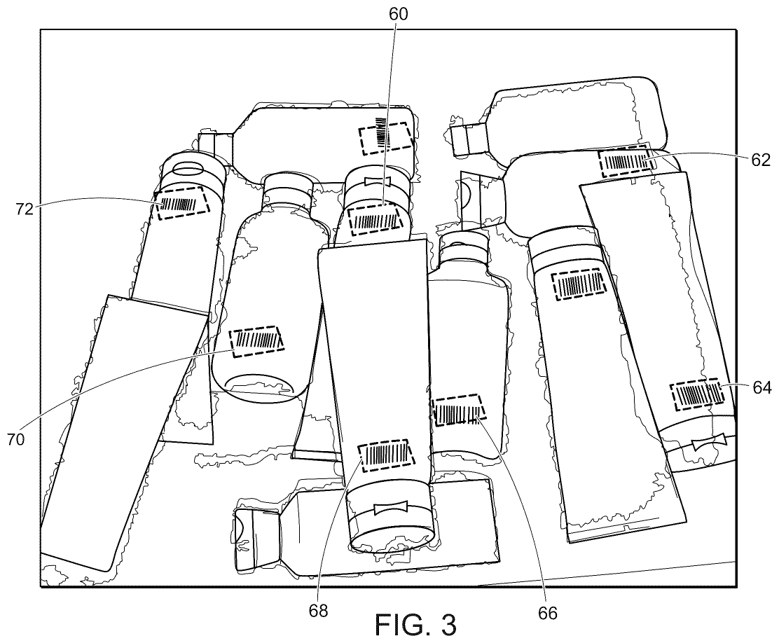

The manner in which inbound objects arrive may, for example, be in one of two configurations: (a) inbound objects arrive piled in bins of heterogeneous objects as shown in FIG. 3; or (b) inbound articles arrive by a moving conveyor. As shown in FIG. 3, the collection of objects includes some that have exposed bar codes as shown at 60, 62, 64, 66, 68, 70 and 72, and other objects that do not have exposed bar codes. The robotic pick and place system is assumed to be able to pick items from the bin or conveyor. The stream of inbound objects is the sequence of objects as they are unloaded either from the bin or the conveyor.

The manner in which outbound objects are organized is such that articles are placed in a bin, shelf location or cubby or other destination location at which all objects corresponding to a given order are consolidated. These outbound destinations may be arranged in vertical arrays, horizontal arrays, grids, or some other regular or irregular manner, but which arrangement is known to the system. The robotic pick and place system is assumed to be able to place objects into all of the outbound destinations, and the correct outbound destination is determined from the SKU of the object.

It is assumed that the objects are marked in one or more places on their exterior with a visually distinctive mark such as a barcode or radio-frequency identification (RFID) tag or other unique identifier so that they may be identified by a scanner. The type of marking depends on the type of scanning system used, but may include 1D or 2D barcode symbologies. Multiple symbologies or labeling approaches may be employed. The types of scanners employed are assumed to be compatible with the marking approach. The marking, either by barcode, RFID tag, or other means, encodes a symbol string, which is typically a string of letters and numbers. The symbol string uniquely associates the object with a SKU.

The primary perception unit 26 is a device mounted above the area where the inbound objects arrive, which scans all inbound objects for identifying features. When inbound objects arrive in bins, the primary perception unit is mounted above the bin. The primary perception unit consists of one or more devices that are able to recognize visually distinctive marks, which may include barcodes or other identifying features, or RFID tags on the objects. Unit components may include cameras, RFID scanners, illuminators, and decoding microprocessors. The primary perception unit makes the first pass at recognizing items in the bin. The primary perception unit localizes any codes that it has found, and the robotic pick and place system is assumed to be able to use that location to pick the item with the given code.

The secondary perception unit 28 (e.g., the secondary scanners) is an assembly that scans any objects that the primary perception unit is unable to scan among the inbound objects, or that scans the objects to confirm the results of the primary perception unit. In further embodiments, the secondary scanners may be used to detect any additional indicia, which may either confirm the identification or may detect that more than one object has been grasped, in which case, both are returned to the input inbound area. Inbound objects in a bin or on a conveyor may have labels or tags partially or completely occluded by other objects, or the labels or tags may not be facing the scanner. The secondary perception unit is mounted in the workspace of the robotic pick and place system so that unidentified articles may be presented to the secondary scanner. Like the primary perception unit, the secondary perception unit consists of one or more perception devices, which may include cameras, RFID scanners, illuminators, and decoding microprocessors.

The operations of the systems described above are coordinated by the central control system 34. This system determines from perception data (e.g., symbol strings) the SKU associated with an object, as well as the outbound destination for the object. The central control system is comprised of one or more workstations or central processing units (CPUs). The correspondence between SKUs and outbound destinations is maintained by the central control system in a database called a manifest. The central control system maintains the manifest by communicating with a warehouse management system (WMS).

During operation, the broad flow of work may be generally as follows. First, the system is equipped with a manifest that provides the outbound destination for each inbound object. Next, the system waits for inbound objects to arrive either in a bin or on a conveyor. When the robotic pick and place system recognizes that one or more inbound objects are present, the central control system instructs the primary perception unit to scan the inbound objects. The primary perception unit creates a list of detected markings, which includes their symbol strings, as well as their positions in the workspace. The primary perception unit transmits this list to the central control system.

The central control system receives from the primary perception unit the perceived information including the detected markings, and from the robotic pick and place system it receives a list of unidentified but pick-able objects. The position coordinates in both lists are registered to one another by employing calibration information about the primary scanner and the robotic pick and place system. The central control system employs the map generated by the robotic pick and place system to determine by simple geometric means the objects that enclose each detected marking. Thus, the central control system associates for each marking the object to which it corresponds. This step is a marking-based data association. The central control system ranks each of the candidate articles to pick based on a heuristic, such as choosing the top-most object in a pile, and so generates a candidate pick list.

Again, FIG. 3 shows an example of a marking-based data association between objects identified by the robotic pick and place system and markings detected by a perception unit. In this instance barcode symbols (bounding quadrilaterals) are associated with the unidentified objects (shaded segments) in which the barcode symbols lie.

If there is at least one candidate pick in the candidate pick list that is associated with a marking, the system picks the highest-ranking pick. The expectation is that the picked object will correspond to the marking previously associated by the central control system, and detected by the primary perception unit. Given that this association may potentially be erroneous, the central control system runs a check. After the object has been removed and separated from the set of inbound objects, the system instructs the primary perception unit to scan the inbound articles again. If the correct object was removed, then the marking associated with it should no longer be in the list of markings detected by the primary perception unit. If the marking associated with the picked item is still there however, then it must be that it picked the wrong item. If it picked the wrong item, then it puts the item back and repeats the process of generating pick candidates from the robotic pick and place system and primary scanner.

If there are no candidate picks associated with a marking, then it picks the object associated with the highest-ranking pick. Since there is no marking associated with the object, it is an unidentified object. After the robotic pick and place system picks the item out of the set of inbound objects, the central control system instructs the robotic pick and place system to move the object to the secondary perception unit for scanning. The central control system instructs the secondary perception unit to scan the unidentified object.

If the secondary perception unit successfully recognizes a marking on the object, then the object is then identified and the central control system commands the robotic pick and place system to transfer the item to the outbound destination determined from the SKU, itself determined from the detected marking.

If the secondary perception unit is unable to recognize a marking on the object, then depending on the configuration of the scanner, the central control system may command the robotic pick and place system to rotate the object to try to make markings visible to the scanners, and to scan the object again. This may occur a number of times to guarantee that if the marking were on the object, then it would be detected. The sequence of locations and orientations of the objects are chosen so as to minimize the average or maximum amount of time that secondary scanning takes. If the object cannot be identified or if the secondary perception unit detects non-matching product identifiers (possibly indicating a double pick), the object may be transferred to a special outbound destination for unidentified objects, or it may be returned to the inbound stream.

This entire procedure operates in a loop until all of the objects in the inbound set are depleted. The objects in the inbound stream are automatically identified, sorted, and routed to outbound destinations.

In accordance with an embodiment therefore, the invention provides a system for sorting objects that arrive by inbound bins and that need to be placed into a shelf of outbound bins, where sorting is to be based on a barcode symbol. In this embodiment, the primary and secondary perception units are able to detect and decode barcode symbologies.

Key specializations in this embodiment are the specific design of the primary and secondary perception units so as to maximize the probability of a successful scan, while simultaneously minimizing the average scan time. The probability of a successful scan and the average scan time make up key performance characteristics. These key performance characteristics are determined by the configuration and properties of the primary and secondary perception units, as well as the object set and how they are marked.

The two key performance characteristics may be optimized for a given item set and method of barcode labeling. Parameters of the optimization for a barcode system include how many barcode scanners to include where and in what orientation to place them, and what sensor resolutions and fields of view for the scanners to use. Optimization can, in certain embodiments, be done by simulation with models of the object.

Optimization through simulation employs a barcode scanner performance model. A barcode scanner performance model is the range of positions, orientations and barcode element size that a barcode symbol can be detected and decoded by the barcode scanner, where the barcode element size is the size of the smallest feature on the barcode. These are typically rated at a minimum and maximum range, a maximum skew angle, a maximum pitch angle, and a minimum and maximum tilt angle.

If a barcode scanner and symbol are held upright, and the barcode symbol is facing the scanner such that the symbol is parallel to the sensor-side of the scanner, then the barcode symbol is in what is called the fronto-parallel plane. The angle between the fronto-parallel plane and a plane that rotates about the vertical axis is the skew angle. The angle between the fronto-parallel plane and a plane that rotates about the horizontal axis is the pitch axis. The angle a feature on the fronto-parallel makes as it rotates about an axis perpendicular to the fronto-parallel plane is the tilt axis.

Typical performances for camera-based barcode scanners are that they are able to detect barcode symbols within some range of distances as long as both pitch and skew of the plane of the symbol are within the range of plus or minus 45 degrees, while the tilt of the symbol can be arbitrary (between 0 and 360 degrees). The barcode scanner performance model predicts whether a given barcode symbol in a given position and orientation will be detected.

The barcode scanner performance model is coupled with a model of where barcodes would expect to be positioned and oriented. A barcode symbol pose model is the range of all positions and orientations, in other words poses, in which a barcode symbol will expect to be found. For the secondary scanner, the barcode symbol pose model is itself a combination of an article gripping model, which predicts how objects will be held by the robotic pick and place system, as well as a barcode-item appearance model, which describes the possible placements of the barcode symbol on the object. For the primary scanner, the barcode symbol pose model is itself a combination of the barcode-item appearance model, as well as an inbound-object pose model, which models the distribution of poses over which inbound articles are presented to the primary scanner. These models may be constructed empirically, modeled using an analytical model, or approximate models can be employed using sphere models for objects and a uniform distribution over the sphere as a barcode-item appearance model.

In an embodiment for example, two objects, a bottle and a toothpaste container, represent the object set, and the barcode symbols are placed in fixed and known locations on all instances of these objects. With a 3D model of these two objects, the known capabilities of the robotic pick and place system are used to generate a random sample of poses of the objects. These poses are with respect to the end-effector of the robotic pick and place system, typically a gripper.

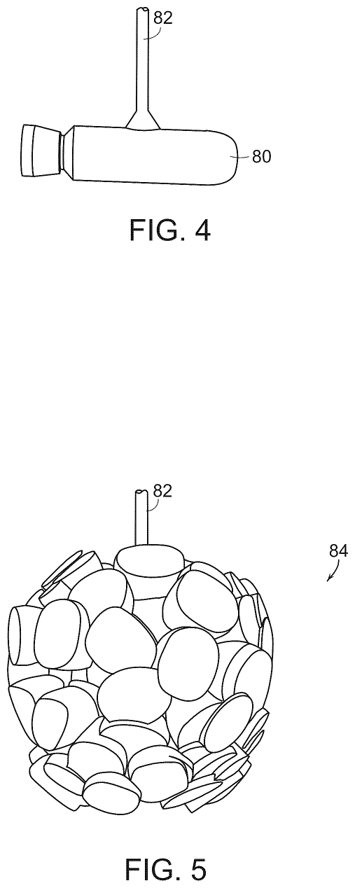

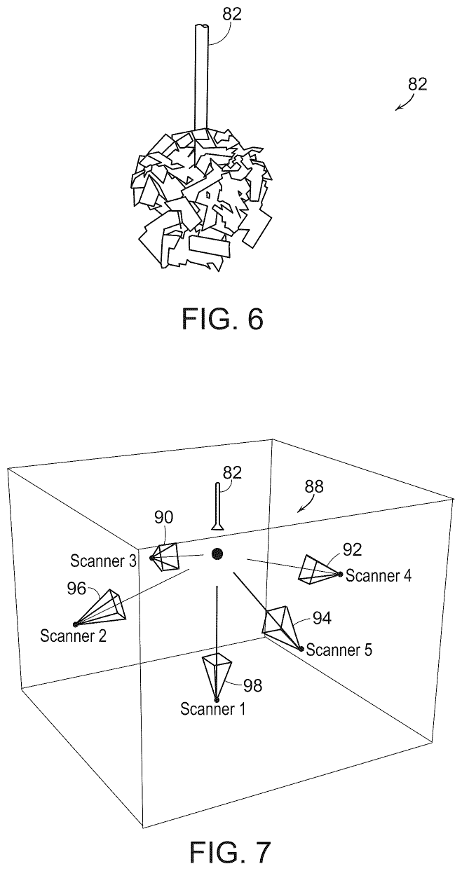

FIG. 4 shows an example of a single simulated hold of a bottle 80, as held by an end effector 82 of a vacuum-gripper-based robotic pick and place system. FIG. 5 shows at 84 overlapping samples of the bottle 80 shown in FIG. 4. With these samples, and because the barcode symbols are at fixed positions on the two articles, a set of poses of barcode symbols are generated. FIG. 6 shows at 86 an example where the quadrilaterals represent 100 sampled barcode symbols. This sample represents the barcode symbol pose model for a secondary scanner. It is an approximation of a probability distribution over where barcodes would expect to be found when the article is held by the robotic pick and place system.

With these models, the barcode symbol pose model and the barcode scanner performance model, optimization over all of the parameters of the system is possible. FIG. 7 shows the resulting configuration, determined by simulation of the above-described models, of a secondary scanner system determined for the instance where the articles are a bottle and toothpaste container. As shown in FIG. 7, the system includes scanners 90, 92, 94, 96 and 98, each of which is generally directed toward an object area 88, while the position of each of the scanners 90-98 is selected to provide optimum planes, angles, tilts and views for the objects in question. FIG. 7 shows a mechanical model of the actualized secondary scanner. In this instance the optimization criteria was the probability of scan success. In instances where only one scanner can be employed, the optimization criteria may be average scan time, in which case the optimization is over the sequence of poses in which to present articles to a secondary scanner so that the average scan time as a whole is decreased.

In accordance with a further embodiment therefore, the invention may be used in connection with an object sortation system that yields a large (and very flexible) number of total collection bins, very low divert costs per bin, throughput as high as that of a manual system, and a far smaller need for manual labor to operate.

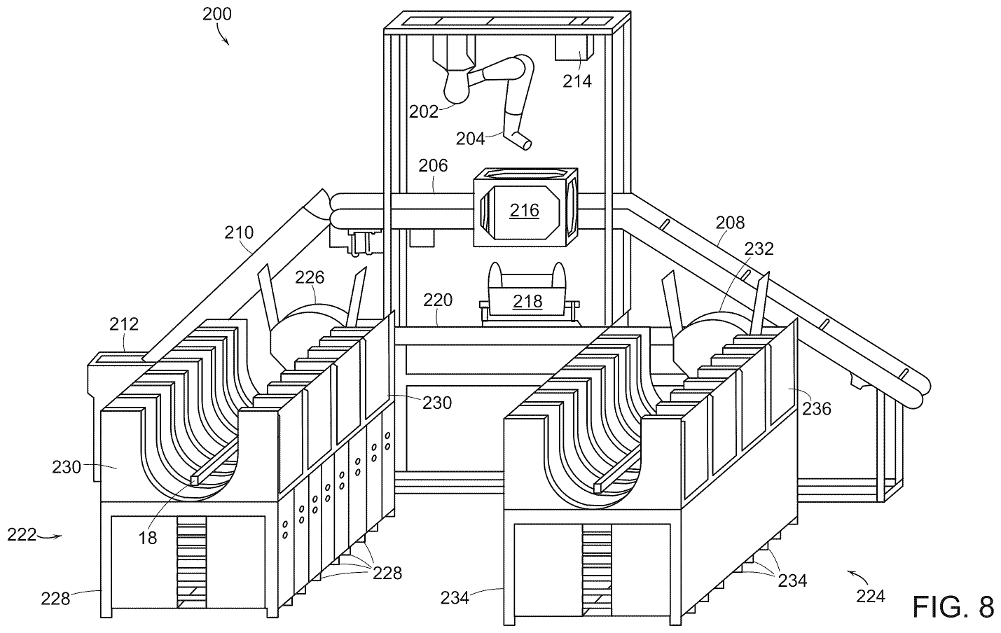

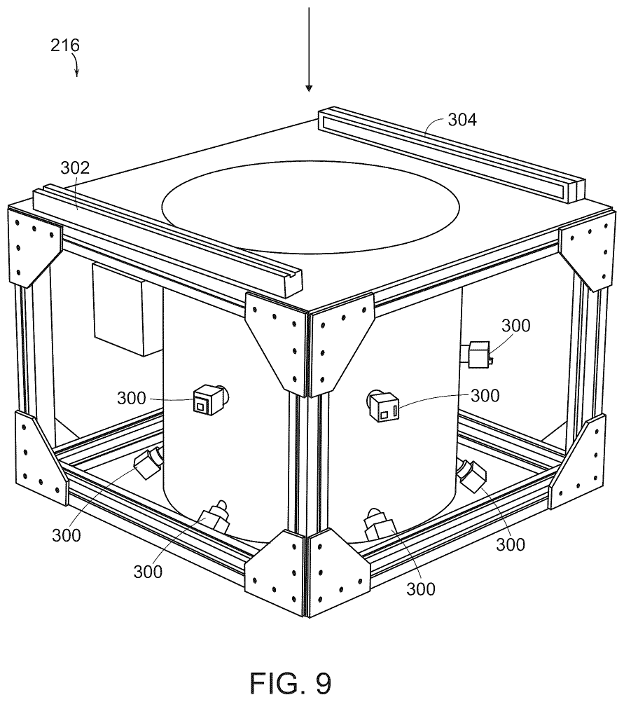

FIG. 8, for example, shows a system 200 that includes an articulated arm 202 with an end effector 204, an input area 206 in which objects are presented for sortation, a primary perception unit 214 such as a camera for identifying objects to be sorted, and a receiving conveyor 208 for receiving objects to be sorted from any of a human worker, another conveyor, or an input pan. The system 200 also includes a non-sortable output chute 210 that leads to a non-sortable output bin 212 for providing objects that the primary perception unit 214 either could not identify or could not sort for any other reason (e.g., could not grasp or pick up).

In addition to the primary perception unit 214, the system also includes a drop perception unit 216 for use as a secondary perception unit, which includes an open top and an open bottom, and a plurality of perception units (e.g., cameras or sensors as discussed above with reference to the previous embodiments) positioned within the drop perception unit 216 that are aimed at the top, mid and lower central regions of the interior of the drop perception unit 216. The plurality of perception units, e.g., cameras, record perception data, e.g., images, of an object when it is dropped by the end effector through the drop perception unit 216. The drop perception unit 216 may also include one or more sensors (e.g., laser sensors) at the top of the drop perception unit 216 that detect when an object is dropped into the drop perception unit 216. The plurality of perception units are designed to collect a plurality of images of each object from multiple views to aid in identifying or confirming the identity of the dropped object.

The dropped object then falls into a first carriage 218 which is provided on a track 220 on which the conveyor 218 may be moved automatically between a first sortation stage 222 and a second sortation stage 224 on either side of the area in which the object was dropped.

The first sortation stage 222 includes a second carriage 226 that may receive objects from the first carriage 218, and which travels along a track between two rows of collection bins 228 into which objects may be dumped along guide walls 230. The second sortation stage 224 includes a third carriage 232 that may receive objects from the first carriage 218, and which travels along a track between two rows of collection bins 234 into which objects may be dumped along guide walls 236.

The system of FIG. 8 shows a system with two shuttle sort wings. When an object is picked from the infeed conveyor, it is dropped onto the first shuttle sorter 218. That shuttle sorter carries the object to one of two wings, drops the object in the carrier for that wing, and then moves back to home. Due to the limited travel, this back and forth operation may be performed in the time it takes the articulated arm to pick another object (assuming the articulated arm is picking objects at approximately a human rate of throughput).

The drop perception unit 216 includes a plurality of detection units (e.g., cameras or scanners as discussed above) that are directed toward a central path such that as an object falls through the drop perception unit 216, multiple views of the object will be captured by the multiple detection units. The drop perception unit may also include lights as discussed above with reference to the system of FIG. 2.

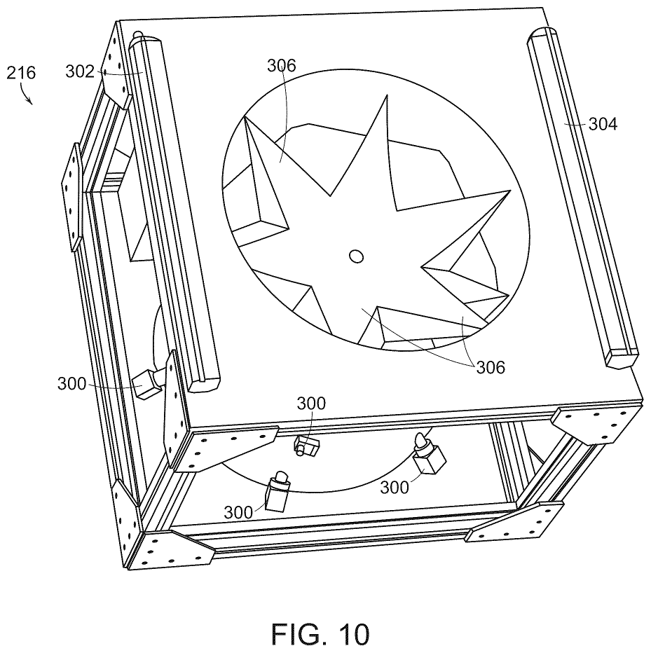

FIGS. 9 and 10 show the detection units 300 directed toward the central path of the drop perception unit 216 at varying angles. As also shown, a laser source bar 302 may direct laser illumination toward a sensor bar 304 such that the drop perception unit 216 may detect exactly when an object enters the drop perception unit 216. FIG. 10 shows at 306 diagrammatic illustrations of the multiple detector angles and fields of view for each of the multiple detectors.

The plurality of additional detection units 300 may be positioned such that every surface of the object may be perceived regardless of the orientation of the object. In certain embodiments, the primary perception unit 214 may provide perception data regarding a unique object identifier, and the plurality of additional detection units 300 may provide additional perception data regarding any of confirming the object identifier or any additional object identifiers. In further embodiments, the primary perception unit 214 may provide perception data regarding an object shape, and the plurality of additional detection units 300 may provide additional perception data regarding a unique object identifier that is confirmed as matching the object shape.

Those skilled in the art will appreciate that numerous modifications and variations may be made to the above disclosed embodiments without departing from the spirit and scope of the present invention.

What is claimed is:

1-39. (canceled)

40. A drop perception unit for acquiring an identity of an object, the drop perception unit comprising:
a frame having a top surface and a bottom surface;
a cylindrical member having a central path, the cylindrical member mounted in the frame with the central path passing through the top surface and the bottom surface, the frame and cylindrical member positioned to orient the central path in a vertical position;
a first set of detection units arranged around a periphery of the cylindrical member near the top surface, each of the first set of detection units having a field of view including the central path;
a second set of detection units arranged around a periphery of the cylindrical member near the bottom surface, each of the second set of detection units having a field of view including the central path; and
a third set of detection units arranged around a periphery of the cylindrical member at a midpoint between the top surface and the bottom surface, each of the third set of detection units having a field of view including the central path.

41. The drop perception unit according to claim 40, wherein the first set of detection units is directed down towards the bottom surface.

42. The drop perception unit according to claim 40, wherein the second set of detection units is directed up towards the top surface.

43. The drop perception unit according to claim 40, wherein the third set of detection units is directed perpendicularly to the central path.

44. The drop perception unit according to claim 40, further comprising a laser source bar and a cooperative detection bar attached to the frame at the top surface to provide a signal upon the entry of an object into the cylindrical member.

45. The drop perception unit according to claim 40, wherein at least one of the detection units in the first set of detection units is at least one of a 2D camera, a 3D camera, a 1D barcode scanner, a 2D barcode scanner, and a radio frequency ID scanner.

46. The drop perception unit according to claim 40, wherein at least one of the detection units in the second set of detection units is at least one of a 2D camera, a 3D camera, a 1D barcode scanner, a 2D barcode scanner, and a radio frequency ID scanner.

47. The drop perception unit according to claim 40, wherein at least one of the detection units in the third set of detection units is at least one of a 2D camera, a 3D camera, a 1D barcode scanner, a 2D barcode scanner, and a radio frequency ID scanner.

48. The drop perception unit according to claim 40, further comprising a plurality of illumination sources.

49. The drop perception unit according to claim 40, wherein at least one of the first set of detection units, the second set of detection units and the third set of detection units provide signals representative of the identity of the object as it falls through the cylindrical member.

50. The drop perception unit according to claim 49, wherein the signals representative of the identity of the object includes a shape of the object.

51. A perception unit comprising:
a cylindrical tunnel oriented in a vertical position with a frame for integration in an object processing system, the cylindrical tunnel having a top portion, a bottom portion, a mid portion, and a central path therethrough;
a first plurality of detection units arranged at the top portion, each of the detection units of the first plurality of detection units pointed toward the central path;
a second plurality of detection units arranged at the mid portion, each of the detection units of the second plurality of detection units pointed toward the central path; and
a third plurality of detection units arranged at the bottom portion, each of the detection units of the third plurality of detection units pointed toward the central path;
wherein, each of the first plurality of detection units, the second plurality of perception units, and the third plurality of detection units provide perception data of an object as it falls through the cylindrical tunnel in the central path.

52. The perception unit according to claim 51, wherein the first plurality of detection units are pointing down.

53. The perception unit according to claim 51, wherein the third plurality of detection units are pointing up.

54. The perception unit according to claim 51, further comprising a plurality of illumination sources directed toward the central path.

55. The perception unit according to claim 51, wherein the first plurality of detection units comprise at least one of a 2D camera, a 3D camera, a 1D barcode scanner, a 2D barcode scanner, and a radio frequency ID scanner.

56. The perception unit according to claim 51, wherein the second plurality of detection units comprise at least one of a 2D camera, a 3D camera, a 1D barcode scanner, a 2D barcode scanner, and a radio frequency ID scanner.

57. The perception unit according to claim 51, wherein the third plurality of detection units comprise at least one of a 2D camera, a 3D camera, a 1D barcode scanner, a 2D barcode scanner, and a radio frequency ID scanner.

58. An object processing system comprising:
a carriage on a track, the carriage moveable between a first sortation stage and a second sortation stage on the track; and
a drop perception unit comprising;
a frame having a top surface and a bottom surface;
a cylindrical member having a central path, the cylindrical member mounted in the frame with the central path passing through the top surface and the bottom surface, the frame and cylindrical member positioned to orient the central path in a vertical position;
a first set of detection units arranged around a periphery of the cylindrical member near the top surface, each of the first set of detection units having a field of view including the central path;
a second set of detection units arranged around a periphery of the cylindrical member near the bottom surface, each of the second set of detection units having a field of view including the central path; and
a third set of detection units arranged around a periphery of the cylindrical member at a midpoint between the top surface and the bottom surface, each of the third set of detection units having a field of view including the central path;
the carriage positioned under the drop perception unit to receive an object dropped through the cylindrical member, the carriage moving the object to one of the first sortation stage and the second sortation stage responsive to an identity of the object provided by at least one of the first set of detection units, the second set of detection units and the third set of detection units.

59. The object processing system according to claim 58, wherein at least one of the detection units in the first set of detection units is at least one of a 2D camera, a 3D camera, a 1D barcode scanner, a 2D barcode scanner, and a radio frequency ID scanner.

60. The object processing system according to claim 58, wherein at least one of the detection units in the second set of detection units is at least one of a 2D camera, a 3D camera, a 1D barcode scanner, a 2D barcode scanner, and a radio frequency ID scanner.

61. The object processing system according to claim 58, wherein at least one of the detection units in the third set of detection units is at least one of a 2D camera, a 3D camera, a 1D barcode scanner, a 2D barcode scanner, and a radio frequency ID scanner.

62. The object processing system according to claim 58, further comprising a laser source bar and a cooperative detection bar attached to the frame at the top surface to provide a signal upon the entry of an object into the cylindrical member.

63. The object processing system according to claim 58, further comprising a plurality of illumination sources disposed within the cylindrical member.

64. The object processing system according to claim 58, wherein each of the first sortation stage and the second sortation stage is a shuttle sorter.
